(19) United States
(12) Patent Application Publication
(10) Pub. No.: US 2003/0152362 A1
(43) Pub. Date: Aug. 14, 2003

(54) Systems and methods for performing editing during filming

(76) Inventor: Robert D. Zantos, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/328,860

(22) Filed: Dec. 23, 2002

Related U.S. Application Data
(60) Provisional application No. 60/345,786, filed on Jan. 4, 2002.
(60) Provisional application No. 60/344,729, filed on Dec. 28, 2001.

(51) Int. Cl. H04N 5/93; G11B 27/00

(52) U.S. Cl. 386/52; 386/55

(57) ABSTRACT

The preferred embodiment of the invention allows the user to assign one or more parameter from a list of parameter to a cut of video footage during its recording. Afterwards, the cut of video footage may immediately be selected according to those parameters and reviewed. Other parameters may also be assigned to the cut of video footage either before or after the recording of that footage. The assignment of parameters may be accomplished via a specialized control box with toggles, knobs, and buttons, or via a touch screen display, or both. Another embodiment allows the recording of video footage onto the hard disk of a computer, after which the computer may act as a server of a wireless network and allows client devices (computers, handheld devices) to access the video footage.

### PRIORITY CLAIM

This application claims the benefit of priority under 35 U.S.C. § 119(e) of U.S. Provisional Application No. 60/345,786 filed on Jan. 4, 2002, titled SYSTEMS AND METHODS FOR PERFORMING EDITING DURING FILMING, and U.S. Provisional Application No. 60/344,729 filed on Dec. 28, 2001, titled MOBILE TELESCOPING CAMERA MOUNT, the entirety of which are incorporated herein by reference.

### FIELD OF THE INVENTION

This invention relates to performing edit functions during the actual filming of an event.

### SUMMARY OF THE INVENTION

The preferred embodiments of the present invention enable a video camera operator to prepare an edit decision list during the actual filming of an event. One preferred embodiment is particularly adopted for filming an athletic event such as a high school football game. The edit list is produced “on the fly” by the individual as he or she films the game with a DV video camera. At the end of the game, the edit list need only be automatically synchronized with the recorded video to provide immediate access to any particular play of the game. As a result, any high school football coach can be provided with play-by-play information much faster than heretofore available to high school coaches.

Another feature of the preferred embodiments of the invention is that they also provide significant economic advantages to professional photographers of non-sporting events such as weddings, wedding receptions, Bar Mitzvahs, birthday parties, and the like. Thus, the camera operator creates the edit decision list during the actual event rather than during the post production of this final video. As a result, a considerable amount of time is saved in the post-production of the final video.

One aspect of a preferred embodiment of this invention is a system in which a DV minicam records directly to a computer hard drive memory. The DV minicam is connected by firewire (IEEE 1394) to a PC computer for recording the mini-DV video from the DV camera to the hard drive of the PC computer during the camera recording. A control box is also coupled to the DV minicam and to the PC computer via serial communication paths. The control box includes a microprocessor pre-programmed for the types of events to be filmed, e.g. football games, weddings, etc. This control box receives time coded data from the DV minicam. As a result, the operator can remotely control the record function of the DV minicam. In addition, the time coded data generated by the DV camcorder is supplied to the microprocessor in the control box which in turn generates an edit decision list for each event recorded by the camera and transmits this list to the hard drive memory of the personal computer. The time code entries of this edit decision list are automatically synchronized with the time coded video data by the PC computer. Selected scenes from the football game, wedding or the like can then be instantly called up for viewing.

Another aspect of the invention is an embodiment in which a DV minicam records to DV tape. After completion of the event, the camera operation downloads the video data and the edit decision list to a PC computer and the computer synchronizes the time coded video and time coded edit decision list.

### BRIEF DESCRIPTION OF THE DRAWINGS

FIGS. 1A and 1B are block diagrams of preferred embodiments of the system;

FIGS. 2A, 2B, 2C, and 2D are perspective views of the control box used by the videographer;

FIG. 3 is a perspective view of the control box and television and computer display monitor;

FIG. 4 illustrates one example of an edit decision list created by a preferred embodiment of this invention; and

FIGS. 5A and 5B illustrate typical displays shown on the display monitor.

### DETAILED DESCRIPTION OF THE PREFERRED EMBODIMENT

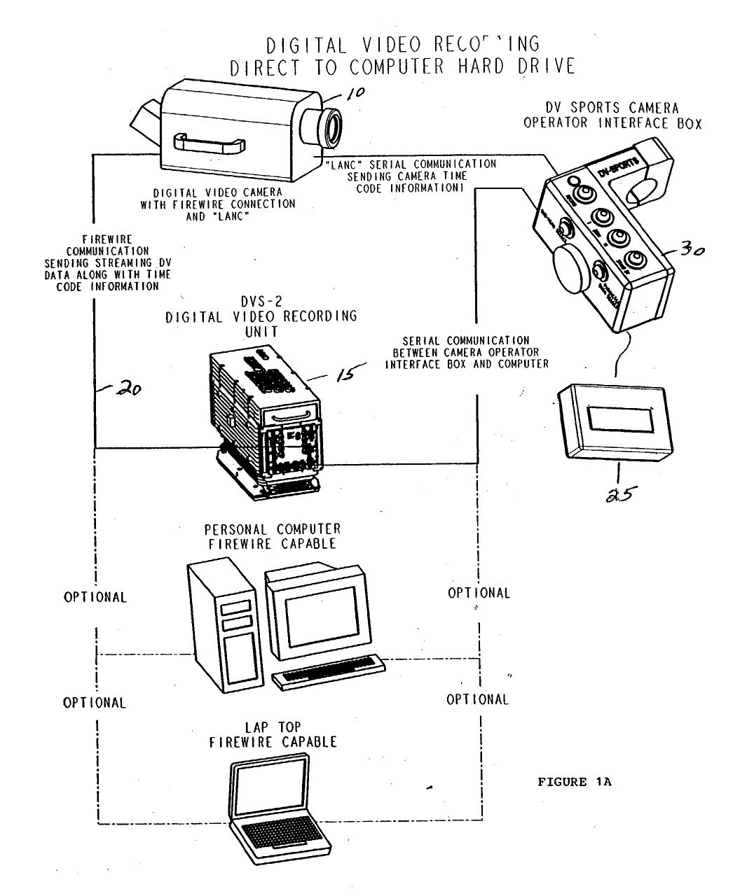

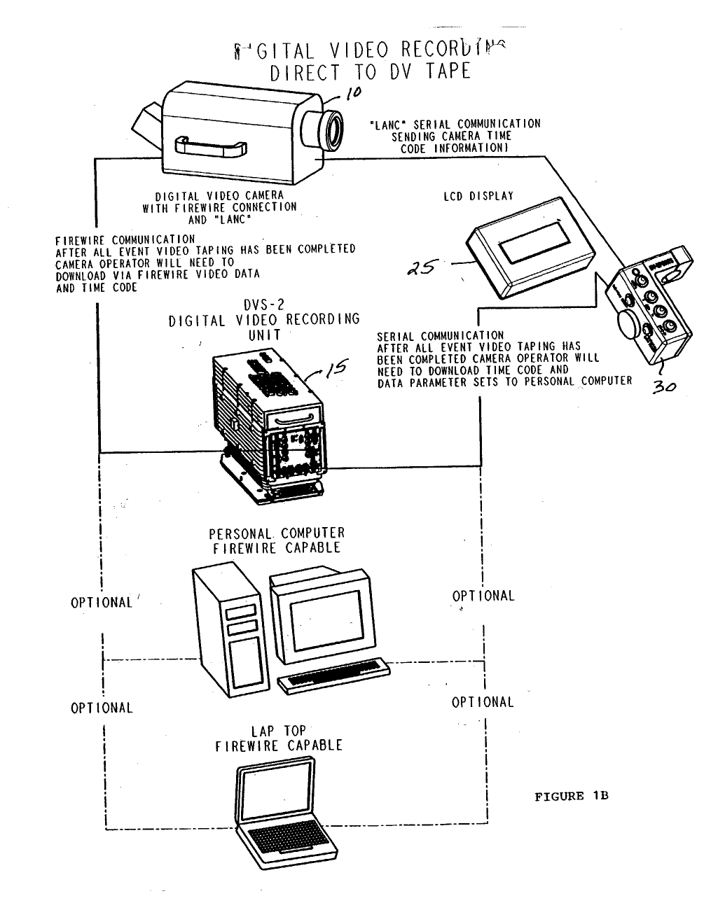

The preferred embodiment shown in FIG. 1A enables the video camera operator to directly record video taken by DV camcord 10 on to a computer hard drive in personal computer 15 (or other firewire capable computer as shown) over firewire 20 (IEEE 1394). As described in detail below, the operator selects individual parameters with control box 30 during the event being photographed.

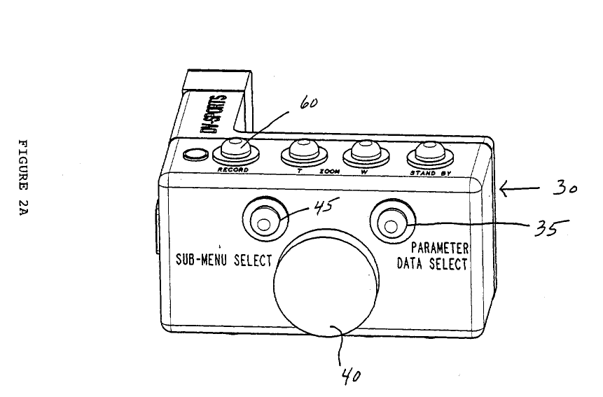

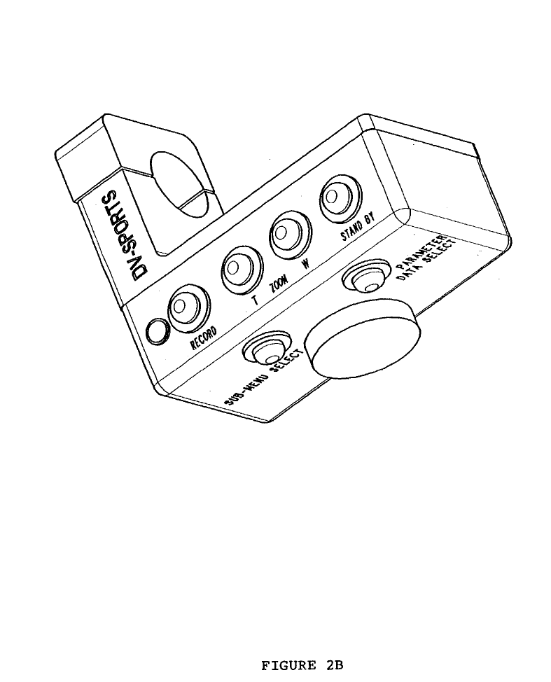

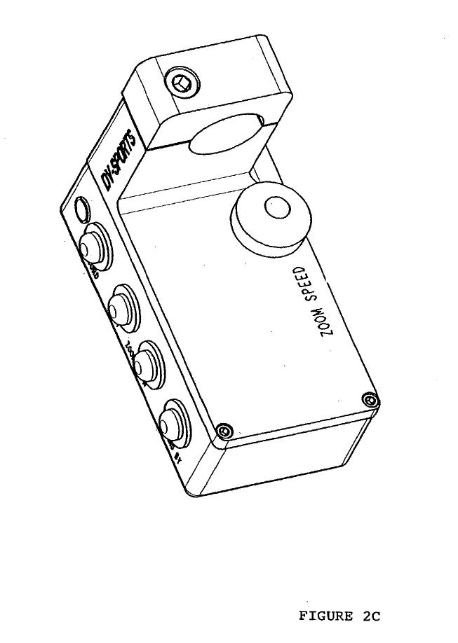

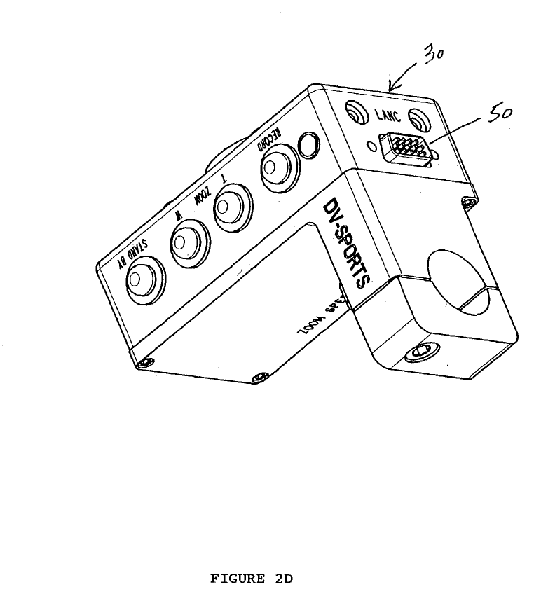

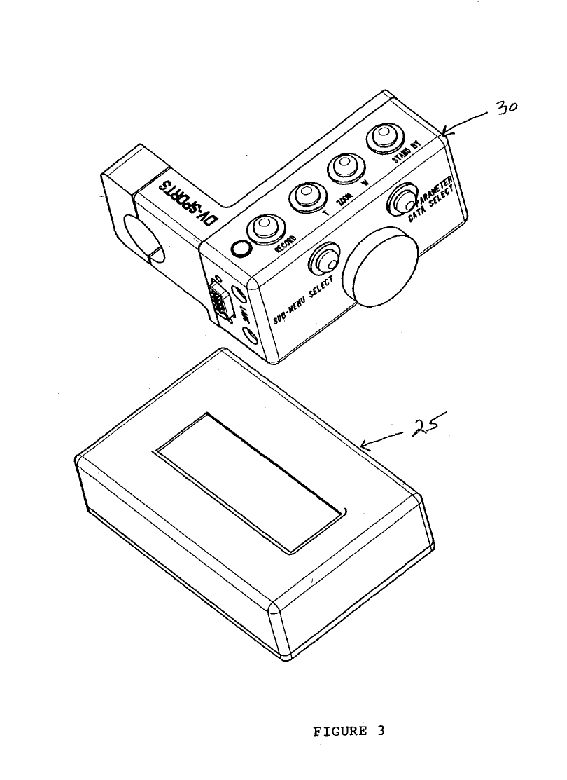

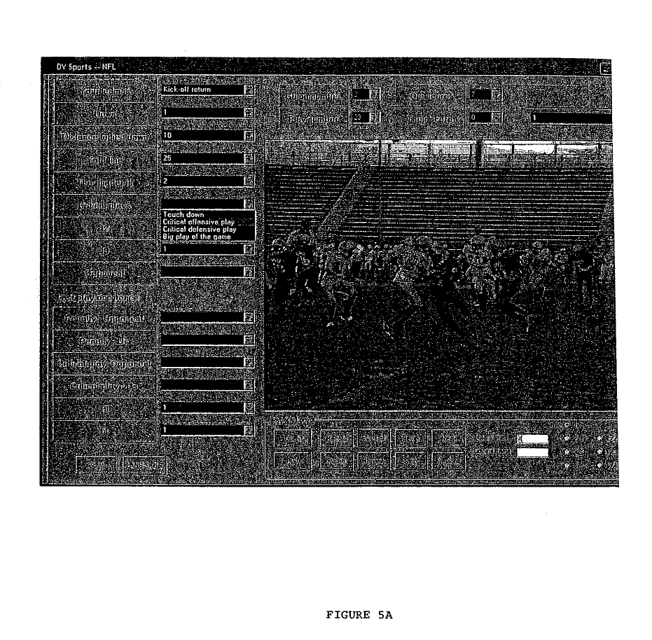

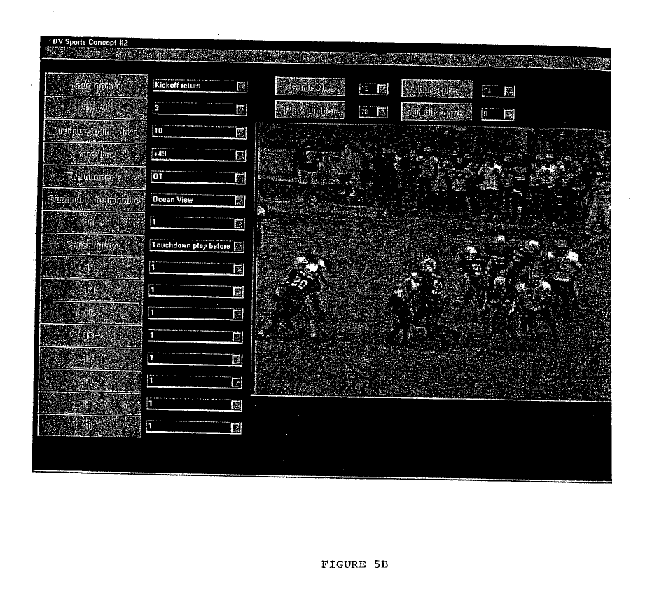

Typically the camera operator views an LED display 25 connected to a control box 30 (best shown in FIGS. 2A-2D and 3) to view the series of parameters that can be adjusted by the operator. Advantageously, the display 25 is also connected to the video output of the DV camcord 10 so that the operator also sees a live video image. Typical monitor displays from a football game are illustrated in FIGS. 5A and 5B.

The individual parameters are selected by depressing a small switch button 35 labeled “Parameter Data Select” located on the parameter adjustment box 30 (best shown in FIG. 2A). Once the camera operator depresses button 35 and keeps it depressed, the operator then rotates the adjustment knob 40. By rotating the adjustment knob 40, the displayed parameters become highlighted on the display 25 with each portion of rotation of the knob. Thus, as the knob 40 is rotated, the individual parameters are selected and then deselected across the display 25. Once the camera operator has chosen a particular parameter to adjust, he or she stops depressing button 35 and the operator will then depress the Sub-Menu button 45. While depressing button 45, the camera operator rotates the adjustment knob 40 and selects which Sub-Menu parameter to change.

In one preferred embodiment, box 30 comprises a sports parameter adjustment box that provides additional features. Thus, it will enable the camera operator to start and stop the recording process by depressing button 60. It will also allow other actions such as: zooming in or out, varying the rate of speed in which the camera operator zooms in or out, bringing the camera from a standby situation to a ready to run situation, turning the on-screen data display on or off, allowing the camera operator to advance the camera or rewind the camera will still in the record mode but not recording, and enabling the camera operator to manually focus the camera by depressing buttons on the parameter adjustment box.

Typically before the camera operator starts recording video at an event, the operator runs a parameter setup program to preprogram into computer 15 the adjustable parameters to be used. This setup program enables new parameter categories and subcategories within the main parameters. Thus, the camera operator first chooses the type of event the operator is about to record. This will bring up on the display monitor 25 the particular set of parameters that are associated with that type of an event. The operator can also go into the set up screen and customize the event parameters and sub parameters.

Once the sub file in computer 15 is complete, the camera operator downloads the setup file to the parameter adjustment box 30 using USB connector 50 (FIG. 2D) from computer 15. From there, the camera operator chooses between different parameters and sub categories within a parameter by the means of the small LCD monitor or display 25. The microprocessor in the DV sports parameter adjustment box 30 have the ability to store many event parameters. This will give the camera operator, for example, the ability to shoot a wedding in the morning and birthday party in afternoon. The software provides predetermined events with predetermined parameters and sub menu parameters the user will be able to customize these parameters and sub menu parameters.

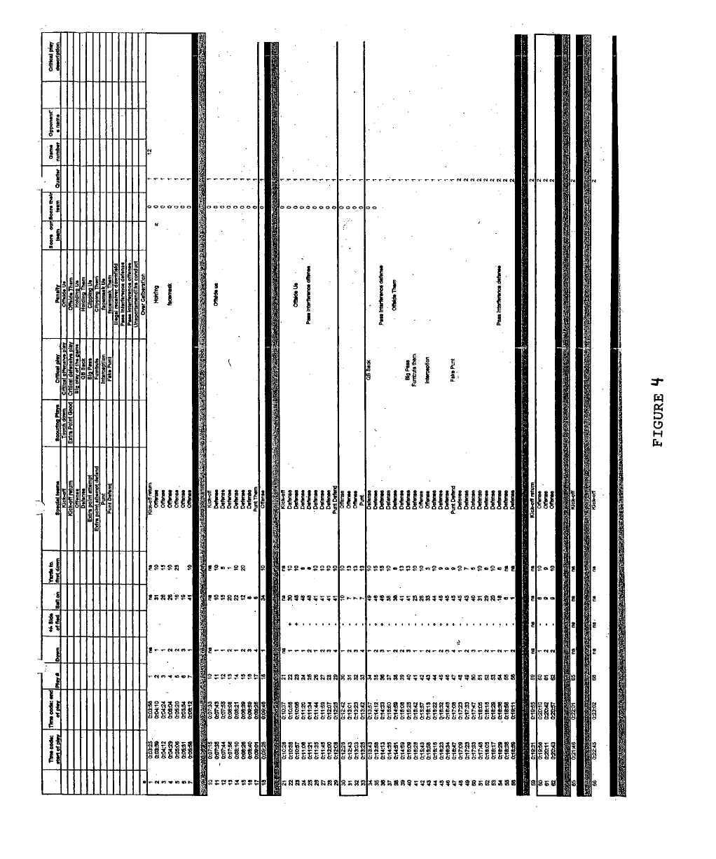

By way of specific example, in recording a football game, some of the parameters to be selected are illustrated in FIG. 4:

Item #1 play No. (every time the camera operator depresses the record button this automatically creates a new play #).

Item #2 Down No (Once the camera operator selects the parameter down number, the operator then selects subcategories of down one to three or four).

Item #3 position of ball on the field (the operator selects from the Sub menu a series of numbers labeled −12 −49 +52 +1).

Item #4 yards to a first down (operator selects from the Sub menu 1 through 50).

Item #5 Special teams (Once the operator has selected the parameter special teams, the operator can select from the following: Kickoff team, kickoff return team, offensive team, defensive team, extra point attempt team, extra point defends an attempt team, punt team, punt defend team, field goal attempt a team, field goal defend team).

Item #8 score our team.

Item #9 score their team.

Item #10 quarter (first, second, third, fourth).

Item #11 game number.

Item #12 opponent's name.

After the fact parameters. Some situations only become apparent after the play has happened, such as touchdowns, penalties, fumbles, and so forth. For this reason, there is a separate category of after the play parameters. This will give the operator to adjust these parameters above for the start of the next play and the software will store those parameters to the previous plays data set.

Item #6 scoring plays (Touch down, extra point, field goal, safety).

Item #7 critical plays (Critical offensive play, critical defensive play, they'd play of the game, quarterback sack, a big pass play, we fumble ball, they fumble ball, we intercepted the ball, they intercepted the ball, faked punt, and so forth).

Item #7 penalties (Offside us, offside them, holding us, holding them, clipping us, clipping them, facemask us, facemask them, and so forth).

By way of another specific example, the wedding photographer will select different parameter categories and subcategories within the main parameters. By way of specific example, these parameters include: father of the bride of walking the bride down to the altar, the wedding ceremony with the pastor giving the vows, the happily married couple walking out of the church, the happily married couple driving away in the limousine, the happily married couple cutting a wedding cake, the happily married couple starting the dance at the wedding reception, the happily married couple leaving for their honeymoon.

Within a parameter such as a wedding reception, sub menus typically include: cutting the cake, the first dance of the bride and groom, the best man toast to the bride and groom, the bride throwing the garter belt.

At an event being recording on a computer hard drive, the operator uses the recorded video and edit list to create a DVD of what he has just recorded. The DVD chapters are the parameters and subchapters relating to the sub menus described above.

### ALTERNATIVE ENTRIES OF PARAMETERS

In another preferred embodiment, the functions of the control box 30, such as the control of camera functions and the entry of parameters (both during play and after plays) may be performed via a user interface displayed on display 25. Advantageously a touch screen display may be used. Alternatively, these functions, as described above, may be divided between the control box 30 and the user interface, for example, such that more frequently used functions are controlled by the control box, while functions that require more detailed selection be performed on the user interface. The user may also have the option of assigning functions or series of functions as a macro to one or more buttons or knob settings on the control box 30.

### INSTANTANEOUS REPLAY

After certain video footage has been recorded and associated with one or more parameters as described above, the video footage may be immediately selected according to these parameters and reviewed. The footage may be reviewed on display 25. In one embodiment, the computer 15 may be equipped with wireless hardware, for example, a wireless network card on the 802.11 or BlueTooth protocol, such that another user similarly equipped may also select the footage according to these parameters and review the resulting footage. In other words, the computer 15 act as a server on a wireless network, and another user may access the computer 15 as a client over a wireless network to access the footage.

### RECORDING TO A VIDEOTAPE/DOWNLOAD TO A COMPUTER/BURN A DVD

In another embodiment shown in FIG. 1B, the video is initially recorded on DV tape.

Once the camera operator has completed videotaping of the event, the video data is synchronized with the time coded and parameters. This is accomplished by downloading the video tape data to the computer hard drive and downloading the time code information from the parameter adjustment box 30 along with the associated parameters and sub menu information to the computer hard drive. Once this is accomplished, the computer software automatically synchronizes the time-coded information with the video data. Once this has been completed, the operator has the ability to choose an order into which the scenes will appear in this final output or select any particular play from the football game list of FIG. 4.

In one preferred embodiment, the system described above is incorporated with the mobile telescopic camera mount described in pending provisional application, Serial No. 60/344,729 filed Dec. 28, 2001. This application is now pending as a regular U.S. application, filed Dec. 20, 2002, and is incorporated herein by reference in its entirety. Thus, the display monitor 25 and parameter adjustment box 30 are installed in the operator control assembly 300 and one more video camcorder 10 are mounted at the top of telescoping most 200 to the camera mounts 204 and 206. Box 30 is advantageously attached to the control handlebars 301, 304. Display 25 is advantageously attached to the base frame 100. Control box 30 is advantageously detachable from the control handlebars of the skyhigh video unit. This is so it can be used for other applications such as scouting an opposing team from the grandstands with the use of video camera and a laptop.

It will be evident to those skilled in the art that the invention is not limited to the details of the foregoing illustrated embodiments and that the present invention may be embodied in other specific forms without departing from the spirit or essential attributed thereof. The foregoing description of the present embodiments is therefore to be considered in all respects as illustrative and not restrictive, with the scope of the invention being delineated by the appended claims and their equivalents.

What is claimed is:

1. A method of editing video footage of an event during the actual filming of the event:
pre-selecting a setup program relating to said event;
displaying on a display monitor the set of parameters in said setup program; and
during the video recording of said game, selecting parameters from said set, before, during or immediately after said recording.

2. A method of editing video footage, comprising:
recording a length of video footage;
selecting a parameter from a list; and
assigning said parameter to said length of video footage immediately before, during, or immediately after said recording of said length of video footage.
